(19) United States
(12) Patent Application Publication
(10) Pub. No.: US 2006/0167191 A1
(43) Pub. Date: Jul. 27, 2006

(54) Additive for optical resins, and optical resin composition

(75) Inventors: Yoshikuni Sasaki, Takatsuki-shi, Osaka (JP); Nobuyuki Ando, Nara (JP); Tatsushi Hirauchi, Osaka (JP); Hayato Ikeda, Nara (JP); Shigefumi Kuramoto, Hyogo (JP)

Correspondence Address: ROBERT J JACOBSON PA, 650 BRIMHALL STREET SOUTH, ST PAUL, MN, 551161511, US

(73) Assignee: Nippon Shokubai Co., Ltd.

(21) Appl. No.: 10/549,243

(22) PCT Filed: Mar. 26, 2004
(86) PCT No.: PCT/JP04/04332

§ 371 Date: Sep. 12, 2005

(30) Foreign Application Priority Data
Apr. 7, 2003 (JP) 2003-103303

(51) Int. Cl. C08L 83/00; C08G 77/00; B32B 9/04

(52) U.S. Cl. 525/474; 528/10

(57) ABSTRACT

There is disclosed an additive for optical resins, wherein, even taking optical uses into consideration, the additive falls off little from such as binder resin layers or resin base materials and enables the exercise of uniform light diffusibility, without luminance unevenness, and high face luminescence. There is further disclosed an optical resin composition which comprises the above additive and a transparent resin and can display very excellent performances in optical properties such as no luminance unevenness and the face luminescence in the case of being employed for optical uses. The additive for optical resins is characterized by comprising organic-inorganic-composite particles having a structure including an organic polymer framework and a polysiloxane framework as essential frameworks. The optical resin composition is characterized by comprising the above additive for optical resins, according to the present invention, and a transparent resin.

### TECHNICAL FIELD

The present invention relates to: an additive for optical resins; and an optical resin composition. More specifically, the present invention relates to: an additive for optical resins for such as light-diffusing sheets and light-leading plates; and an optical resin composition containing this additive.

### BACKGROUND ART

Attempts have hitherto been made to enhance such as properties or usefulness of resins or resin compositions (which are utilized for various uses) by adding thereto fine particles. This is the same also as to optical resins which are used as materials for optical uses such as LCD, PDP, EL displays, and touch panels. For example, as to optical resin sheets such as light-diffusing sheets, there are known those which are obtained by coating a surface of a predetermined base material with a resin composition prepared by mixing fine inorganic particles (of such as titanium oxide, glass beads, and silica) or fine resin particles (made of such as silicone resins, acrylic resins, or polystyrene) into a transparent resin as a binder (e.g. refer to patent documents 1 to 4 below). In addition, as to light-leading plates, there is known a resin composition obtained by adding resin particles (made of such as acrylic resins) into a transparent resin (e.g. polycarbonate) as a base material (e.g. refer to patent document 5 below).

However, in the case where optical uses are taken into consideration in respect to the affinity between the fine particles and the resins (binder resins, resin base materials), the aforementioned various resin compositions lack the practicability or cannot be said to be sufficient. Specifically, at or near surfaces of the resin compositions, the fine particles tend to fall off from such as binder resin layers or resin base materials. For the cause of this, the fallen-off fine particles unfavorably hurt surfaces of the binder resin layers or surfaces of the resin base materials. As a result, for example, in optical uses such as optical sheets (e.g. light-diffusing sheets and light-leading plates), there occur problems such that their optical properties are greatly deteriorated or cannot sufficiently be exercised.

Particularly as to the fine inorganic particles, their affinity to the resins which are media is so low that the fine particles unfavorably fall off easily due to such as stress caused during the winding with a roll or bending, or due to such as impact force and frictional force during the surface contact with such as other base materials, when the resin composition containing the fine particles is produced or when this resin composition is handled in processes of making various optical apparatus products. Therefrom it also follows that the fine inorganic particles lack the practicability as materials employed for optical uses. On the other hand, the fine resin particles can be said to have higher affinity to the resins when compared with the above fine inorganic particles, and also the falling off of the fine resin particles from the resins can be reduced in some degree. However, if it is taken into consideration that very high levels of optical properties have become demanded more and more with recent years' great technical progress in technical fields of such as various optical apparatuses, and that optical materials of still higher quality and still higher performance are requested to be developed and supplied, then even the aforementioned fine resin particles still cannot be said to have sufficient affinity to the resins, and also the damage done by the fallen-off fine particles is great in such a degree as cannot be ignored.

For the aforementioned reasons as stated about the fine particles as the additives, it is still impossible to say that the resin compositions for optical uses have sufficient performances in optical properties. In addition, this respect becomes still more remarkable if it is taken into consideration that the resin compositions for optical uses should be the optical materials of still higher quality and still higher performance. Specifically, the above respect becomes still more remarkable as to the degree of luminance unevenness (dispersion of local luminance) or the face luminescence (magnitude of luminance as a whole) in various optical materials such as light-diffusing sheets and light-leading plates.

As is aforementioned, as to various resin compositions containing the fine inorganic particles, many of the fine particles fall off therefrom, thus resulting in a large degree of luminance unevenness. As to fine particles which have not fallen off and fine particles which are present inside the resin composition, the interface (contact face) between the resin and the fine particle is dissociated (which is called interfacial cracking) due to the stress caused such as during the winding or bending. Therefore, for the cause of this, the degree of luminance unevenness becomes still larger. The lowness of the affinity of the fine inorganic particles to the resin exercises an influence also on the lowness of the dispersibility of the fine particles themselves in the resin, thus resulting in a non-uniform dispersed state (state of the presence). This is a factor of increasing the degree of luminance unevenness. In general, the fine inorganic particles differ greatly from the resin in refractive index and are low in light transmission efficiency, and are therefore very inferior in point of the face luminescence. On the other hand, as to various resin compositions containing the fine resin particles, the falling-off is not seen so much as that in the case of containing the fine inorganic particles. However, the degree of luminance unevenness is still too large if it is taken into consideration that the resin compositions should be the optical materials of still higher quality and still higher performance. As to fine resin particles which have not fallen off and fine resin particles which are present inside the resin composition, the inside of the fine particles themselves is destroyed (such as cracks occur to their inner structures) due to the stress caused such as during the winding or bending. Or, depending on the type of the fine resin particles, the fine particles themselves become deformed plastically in the case where heat is applied during the production of the resin composition. Therefore, for the cause of these, the degree of luminance unevenness becomes still larger. The various resin compositions containing the fine resin particles cannot be said to be sufficient, either, in point of the face luminescence. The refractive index, deriving from a resin portion (organic polymer portion), of the fine resin particle generally satisfies the range appropriate for obtaining excellent face luminescence. However, for the cause of the above inside destruction and plastic deformation of the fine resin particles themselves, it is impossible to obtain the originally possessed appropriate refractive index, so that the face luminescence is inferior. This respect also becomes still more remarkable if it is taken into consideration that the resin compositions should be the optical materials of still higher quality and still higher performance.

[Patent Document 1]

JP-A-172801/1989 (Kokai)

[Patent Document 2]

JP-A-027904/1995 (Kokai)

[Patent Document 3]

JP-A-249525/2002 (Kokai)

[Patent Document 4]

Japanese Patent No. 3306987

[Patent Document 5]

Japanese. Patent No. 3100853

### DISCLOSURE OF THE INVENTION

### Objects of the Invention

Thus, an object of the present invention is to provide an additive for optical resins, wherein, even taking optical uses into consideration, the additive falls off little from such as binder resin layers or resin base materials and enables the exercise of uniform light diffusibility, without luminance unevenness, and high face luminescence. Another object of the present invention is to provide an optical resin composition which comprises the above additive and a transparent resin and can display very excellent performances in optical properties such as no luminance unevenness and the face luminescence in the case of being employed for optical uses.

### SUMMARY OF THE INVENTION

The present inventors diligently studied to solve the above problems.

In its process, the present inventors have decided to direct their attention to fine particles having both an inorganic portion and an organic portion therein and then completed the present invention by finding out and confirming that, if in such fine particles, organic-inorganic-composite particles, which have a polysiloxane framework structure as the inorganic portion and an organic polymer framework structure as the organic portion and are in a composite body of both these framework structures, are used for the additive for optical resins, then the above problems can be solved all at once.

That is to say, an additive for optical resins, according to the present invention, is characterized by comprising organic-inorganic-composite particles having a structure including an organic polymer framework and a polysiloxane framework as essential frameworks. In addition, an optical resin composition, according to the present invention, is characterized by comprising the above additive for optical resins, according to the present invention, and a transparent resin.

Many parts of reasons why the above organic-inorganic-composite particles are more excellent in point of little falling off from the transparent resin (which is used as a medium) (e.g. binder resin, resin base material) when used as the additive for optical resins than conventional various fine particles even from the viewpoint of high performance levels as demanded particularly in recent years' optical uses are unclear as matters now stand. However, the above reasons can be inferred as follows. The organic-inorganic-composite particles, which are used as the present invention additive for optical resins, have the resin portion deriving from the organic polymer framework. Therefore, when compared at least with conventional fine inorganic particles, the organic-inorganic-composite particles are higher (better) in affinity to the resin (which is used as a medium) and therefore considerably less fall off therefrom. In addition, also when compared with conventional fine resin particles, the affinity to the resin is still more excellent. Its reason can be considered to be as follows. The organic-inorganic-composite particles have a network-structured framework based on the polysiloxane. Therefore, the resin (which is used as a medium) becomes tangled appropriately with the network structure near surfaces of the particles. As a result, the adhesion of the particles to the resin is greatly enhanced to exercise a great influence on the prevention of the falling-off. In addition, the above network structure further provides the particles themselves with appropriate softness and elasticity. Therefore, even if the particles undergo the frictional force or the stress, the appropriate buffering function works to thus prevent the falling-off. From the above, the aforementioned possession of the organic portion and the inorganic portion in combination can be considered to be a factor of greatly enhancing the prevention of the falling-off from the resin.

As to reasons why the product which is excellent in the uniformity without luminance unevenness is obtained in the case where the optical resin composition according to the present invention is used as an optical material, it can be cited such that the dispersibility of the organic-inorganic-composite particles into the resin (which is used as a medium) is good, in addition to that, as is aforementioned, the organic-inorganic-composite particles fall off very little. As to reasons why the organic-inorganic-composite particles are greatly excellent also in comparison with the case of the use of fine resin particles, they can further be inferred as follows. As to the fine resin particles which have hitherto been used, they may, in some degree, have a tendency to little fall off and the dispersibility in the resin. However, in the case where the stress is caused by such as bending in processes of producing the resin composition, there is a possibility that the difference between the resin and the particle as to the distortion ratio may destroy the inside structure of the fine resin particles partly in the resin composition. So dispersions of optical properties of the particles are caused in respect to light transmittance or refractive index. For the cause of this, the luminance unevenness becomes seen. Furthermore, in the case where a step which involves heating is included in processes of producing the resin composition, there is a possibility that the fine resin particles may become plastically deformed due to heat partly in the resin composition. So, similarly to the above, dispersions of optical properties of the particles are caused, so that the luminance unevenness becomes seen. In comparison, as is aforementioned, the organic-inorganic-composite particles, which are used as the present invention additive for optical resins, have the appropriate softness and elasticity deriving from the polysiloxane framework. Therefore, even in the case where the aforementioned stress is caused in processes of producing the resin composition, the contained particles can follow the distortion ratio of the resin, so that such as the above inside destruction is not caused or is greatly prevented. In addition, the polysiloxane framework provides not only the appropriate softness but also the restorability of the particle shape. Therefore, also as to the above plastic deformation, it is not caused or is greatly prevented.

As to reasons why the product which is excellent in the face luminescence is obtained in the case where the optical resin composition according to the present invention is used as an optical material, it can be cited such that there is possessed an appropriate refractive index deriving from the resin portion (organic polymer framework portion), and further that, as is mentioned above, the inside destruction or plastic deformation of the added particles is not caused or is greatly prevented.

Further surprisingly, as to the organic-inorganic-composite particles which are used as the present invention additive for optical resins, those which have particle diameters being desired can be obtained in a state where their particle diameter distribution is extremely narrow. Therefore, in the case where actually the optical resin composition is obtained and then used as an optical material, not only can the productivity enhancement and the cost reduction be achieved, but also the optical and physical properties of the resin composition can be enhanced. Specifically, the particle diameters of the above organic-inorganic-composite particles almost depend on the polysiloxane framework as the inorganic portion. As to polysiloxane particles consisting of this framework, those which have particle diameters being desired can be obtained in a state where their particle diameter distribution is extremely narrow by reason of their production process. Therefore, also as to the organic-inorganic-composite particles, those which have particle diameters appropriate for desired uses can be obtained in a state where their particle diameter distribution is extremely narrow while consideration is made so that excellent optical properties can be displayed. So, if the organic-inorganic-composite particles are added to the resin in the same ratio as conventional, it is clearly possible to exercise optical performances which are more excellent than conventional. In addition, even in the case where performances which are on the same level as conventional or more excellent than conventional should be exercised, the content can be made lower than conventional, so the productivity and the economical advantage are excellent. In the case where the content is lowered, the following further effects can also be expected. For example, in the case where the optical resin composition according to the present invention is used for such as light-leading plates or light-diffusing sheets, effects such as light diffusibility can be obtained enough, and further, the light loss depending on the fine-particle content can be reduced effectively. In this respect, particularly in technical fields of such as LCD, even though only the light-leading plate is used without the light-diffusing sheet equipped, it is possible that the function of transmission of light from a light source which function is originally possessed by the light-leading plate is prevented from deteriorating, and further that both performances of excellent face luminescence and light diffusibility are combined. Therefore, the above content lowering can be said to be extremely effective. In addition, if the fine-particle content can be lowered, the physical properties such as physical strength and softness of the resin itself (which is used as a medium) can necessarily be reflected in the resulting resin composition.

### DETAILED DESCRIPTION OF THE INVENTION

Hereinafter, detailed descriptions are given about the additive for optical resins and the optical resin composition according to the present invention. However, the scope of the present invention is not bound to these descriptions. And other than the following illustrations can also be carried out in the form of appropriate modifications of the following illustrations within the scope not departing from the spirit of the present invention.

[Additive for Optical Resins]:

The additive for optical resins according to the present invention (which may hereinafter be referred to as present invention additive) comprises organic-inorganic-composite particles (which may hereinafter be referred to simply as composite particles) having a structure including an organic polymer framework and a polysiloxane framework as essential frameworks.

Hereinafter, descriptions are given about such as structure of the above organic-inorganic-composite particles being the present invention additive and further about the process for production of the composite particles.

The composite particles are particles including the organic polymer framework as the organic portion and the polysiloxane framework as the inorganic portion. The composite particles may be either in a) a form (chemical bond type) such that the polysiloxane framework has in its molecule an organosilicon atom such that a silicon atom is directly and chemically bonded to at least one carbon atom of the organic polymer framework or b) a form (IPN type) which does not have such an organosilicon atom in its molecule. Thus, there is no especial limitation. In detail, as the above form a), there is preferred a form such that a silicon atom of the polysiloxane framework and a carbon atom of the organic polymer framework are bonded together, whereby the polysiloxane framework and the organic polymer framework constitute a three-dimensional network structure. As the above form b), there is preferred a form such that an organic polymer is contained in the structure of particles consisting of the polysiloxane framework (polysiloxane particles) and, in more detail, there is preferred a particle form such that the organic polymer exists between frameworks of the network-shaped polysiloxane framework structure constituting the polysiloxane particles (in spaces between the above frameworks), wherein the polysiloxane and the organic polymer are in a composite body of both them while forming their respective framework structures independently of each other.

The organic polymer framework is a framework structure including at least the main chain of the main chain, side chain, branch chain, and crosslinking chain deriving from the organic polymer. There is no especial limitation on such as molecular weight, composition, and structure of the organic polymer constituting the framework or on such as whether this organic polymer has a functional group or not. It is favorable that the organic polymer is, for example, at least one member selected from the group consisting of vinyl polymers (e.g. (meth)acrylic resins, polystyrenes, and polyolefins), polyamides (e.g. nylon), polyimides, polyesters, polyethers, polyurethanes, polyureas, polycarbonates, phenol resins, melamine resins, and urea resins.

For the reason that the hardness of the composite particles can appropriately be controlled, the form of the organic polymer framework is favorably a polymer (what is called vinylic polymer) having the main chain which is constituted by chemical bonding of repeating units represented by the following formula (1):

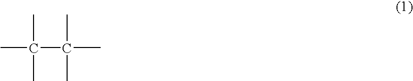

The polysiloxane framework is defined as a compound such that a network-structured network is constituted by continuous chemical bonding of siloxane units represented by the following formula (2): 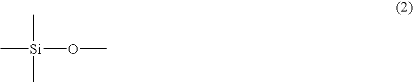
The amount of SiO₂ constituting the polysiloxane framework is favorably not smaller than 0.1 weight %, more favorably in the range of 0.5 to 90 weight %, still more favorably 1.0 to 80 weight %, relative to the weight of the composite particles. If the amount of SiO₂ in the polysiloxane framework is in the above range, the aforementioned effects expectable from the polysiloxane framework can be exercised enough. In addition, in the case where the above amount is smaller than 0.1 weight %, there is a possibility that the softness and elasticity of the particles may be deteriorated, thus resulting in occurrence of problems such that the inside of the particles is destroyed when the stress is caused by external force applied to the resin composition. In the case where the above amount is larger than the above range, there is a possibility that the adhesion between the particle and the resin may be deteriorated, thus resulting in a tendency for the particles to fall off from the resin composition. Incidentally, the amount of SiO₂ constituting the polysiloxane framework is a weight percentage determined by measuring the weights before and after calcining the particles at a temperature of not lower than 1,000° C. under an oxidizable atmosphere such as air.

As to the composite particles used as the present invention additive, the ratio between the number of carbon atoms and the number of silicon atoms at the surfaces of the particles (ratio between numbers of surface atoms (C/Si)) which is determined by photoelectron spectroscopy is in the range of 1.0 to 1.0×10⁴ favorably in point of being excellent in the adhesion to the resin used as a medium. In the case where the above ratio between numbers of surface atoms (C/Si) is smaller than 1.0, there is a possibility that the adhesion to the resin may be deteriorated. In addition, in the case where the above ratio is larger than 1.0×10⁴, there is a possibility that the softness and elasticity of the particles may be deteriorated, thus resulting in occurrence of problems such that the inside of the particles is destroyed when the stress is caused by external force applied to the resin composition.

Although not especially limited, the average particle diameter of the composite particles used as the present invention additive is favorably in the range of 0.01 to 200 μm, more favorably 0.05 to 100 μm, still more favorably 0.1 to 80 μm. If the average particle diameter is in the above range, then the composite particles, as the additive for optical resins, can provide advantageous effects such that the resultant optical resin composition can be made to display excellent light diffusibility and face luminescence. In the case where the above average particle diameter is smaller than 0.01 μm, there is a possibility that no sufficient light-diffusing effect can be obtained. In the case where the above average particle diameter is larger than 200 μm, there is a possibility that the dispersibility into the resin (which is used as a medium) may be deteriorated.

Although not especially limited, the narrowness of the particle diameter distribution of the composite particles used as the present invention additive is favorably not more than 50%, more favorably not more than 25%, still more favorably not more than 10%, when represented by coefficient of variation (CV value) in particle diameter. If the above coefficient of variation (CV value) is in the above range, then, for example, the composite particles, as the additive for optical resins, can provide advantageous effects such that the resultant optical resin composition can be made to display excellent light diffusibility and face luminescence. In the case where the above coefficient of variation (CV value) is more than 50%, there is a possibility that the optical properties such as light diffusibility and face luminescence cannot sufficiently be displayed.

As to the composite particles, each of their physical properties such as hardness and fracture strength can be adjusted arbitrarily by appropriately changing the ratios of the polysiloxane framework portion and the organic polymer framework portion.

Although not especially limited, examples of the shape of the composite particles include shapes of spheres, needles, sheets, flakes, splinters, rugby footballs, cocoons, and stars. Particularly, in the case where the composite particles are used as the additive for optical resins (case where the composite particles are used for the optical resin composition), it is favorable that the shape of the composite particles is the shape of a true sphere or the shape approximately near to the true sphere, of which the ratio of the long particle diameter to the short particle diameter is in the range of 1.00 to 1.20, and that the coefficient of variation in particle diameter is not more than 50%.

The present invention additive is used as an additive (e.g. a light-diffusing agent, an anti-blocking agent) for optical resins which are used for such as light-diffusing sheets and light-leading plates (these sheets and plates are used for such as LCD) or PDP, EL displays, and touch panels. However, the uses are not especially limited to these. For example, besides, the present invention additive is useful also as such as an anti-blocking agent for various films.

Examples of the above optical resins include various resins which are cited as examples in the below-mentioned explanation of the optical resin composition according to the present invention.

The polysiloxane framework in the composite particles, which are used as the present invention additive, is obtained favorably by hydrolysis-condensation reactions of silicon compounds having hydrolyzable groups.

Although not especially limited, examples of the silicon compounds having hydrolyzable groups include silane compounds and their derivatives, wherein the silane compounds are represented by the following general formula (3):
R¹ₘSiX₄₋ₘ (3)
(wherein: R¹ may have a substituent and represents at least one kind of group selected from the group consisting of alkyl groups, aryl groups, aralkyl groups, and unsaturated aliphatic groups; X represents at least one kind of group selected from the group consisting of alkoxy groups and acyloxy groups; and m is an integer of 0 to 3).

Although not especially limited, examples of the silicon compounds represented by the above general formula (3) include: as those of m=0, tetrafunctional silanes such as tetramethoxysilane, tetraethoxysilane, tetraisopropoxysilane, and tetrabutoxysilane; as those of m=1, trifunctional silanes such as methyltrimethoxysilane, methyltriethoxysilane, ethyltrimethoxysilane, ethyltriethoxysilane, hexyltrimethoxysilane, decyltrimethoxysilane, phenyltrimethoxysilane, benzyltrimethoxysilane, naphthyltrimethoxysilane; methyltriacetoxysilane, β-(3,4-epoxycyclohexyl)ethyltrimethoxysilane, 3-glycidoxypropyltrimethoxysilane, vinyltrimethoxysilane, 3-(meth)acryloxypropyltrimethoxysilane, and 3,3,3-trifluoropropyltrimethoxysilane; as those of m=2, difunctional silanes such as dimethyldimethoxysilane, dimethyldiethoxysilane, diacetoxydimethylsilane, and diphenylsilanediol; and, as those of m=3, monofunctional silanes such as trimethylmethoxysilane, trimethylethoxysilane, and trimethylsilanol.

Preferable of these are silane compounds which have a structure of m=1 in the above general formula (3), and of which the X in this formula is a methoxy group or ethoxy group, and which have a refractive index of 1.30 to 1.60. Because such silane compounds can provide organic-inorganic-composite particles having a refractive index which is favorable as an additive for optical resins. Specific examples thereof include methyltrimethoxysilane, phenyltrimethoxysilane, 3-(meth)acryloxypropyltrimethoxysilane, β-(3,4-epoxycyclohexyl)ethyltrimethoxysilane, and 3,3,3-trifluoropropyltrimethoxysilane.

Although not especially limited, examples of the derivatives from the silicon compounds represented by the above general formula (3) include: compounds of which a part of the X is displaced with a group that can form a chelate compound (e.g. a carboxyl group, a β-dicarbonyl group); and oligocondensation products obtained by partially hydrolyzing the above silane compounds.

The hydrolyzable silane compounds may be used either alone respectively or in appropriate combinations with each other. In the case where only the silane compounds of m=3 in the above general formula (3) and derivatives therefrom are used as the starting materials, it is impossible to obtain the composite particles.

In the case where the composite particles, which are used as the present invention additive, are in the form such that the polysiloxane framework has in its molecule an organosilicon atom such that a silicon atom is directly bonded to at least one carbon atom of the organic polymer framework, then, as the above hydrolyzable silane compounds, it is necessary to use those which have an organic group containing a polymerizable reactive group which can form the organic polymer framework. Examples of the reactive group include a radically polymerizable group, an epoxy group, a hydroxyl group, and an amino group.

Examples of the organic group containing the radically polymerizable group include radically polymerizable groups represented by the following general formulae (4), (5) and (6):
CH₂═C(—R^{a})—COOR^{b}— (4)
(wherein: R^{a} represents a hydrogen atom or a methyl group; and R^{b} represents a divalent organic group having 1 to 20 carbon atoms, which may have a substituent);
CH₂═C(—R^{c})— (5)
(wherein: R^{c} represents a hydrogen atom or a methyl group); and
CH₂═C(—R^{d})—R^{e}— (6)
(wherein: R^{d} represents a hydrogen atom or a methyl group; and R^{e} represents a divalent organic group having 1 to 20 carbon atoms, which may have a substituent).

Examples of the organic group of the above general formula (4) containing the radically polymerizable group include an acryloxy group and a methacryloxy group. Examples of the silicon compound of the above general formula (3) having this organic group include γ-methacryloxypropyltrimethoxysilane, γ-methacryloxypropyltriethoxysilane, γ-acryloxypropyltrimethoxysilane, γ-acryloxypropyltriethoxysilane, γ-methacryloxypropyltriacetoxysilane, γ-methacryloxyethoxypropyltrimethoxysilane (which is otherwise called γ-trimethoxysilylpropyl β-methacryloxyethyl ether), γ-methacryloxypropylmethyldimethoxysilane, γ-methacryloxypropylmethyldiethoxysilane, and γ-acryloxypropylmethyldimethoxysilane. These may be used either alone respectively or in combinations with each other.

Examples of the organic group of the above general formula (5) containing the radically polymerizable group include a vinyl group and an isopropenyl group. Examples of the silicon compound of the above general formula (3) having this organic group include vinyltrimethoxysilane, vinyltriethoxysilane, vinyltriacetoxysilane, vinylmethyldimethoxysilane, vinylmethyldiethoxysilane, and vinylmethyldiacetoxysilane. These may be used either alone respectively or in combinations with each other.

Examples of the organic group of the above general formula (6) containing the radically polymerizable group include a 1-alkenyl group or a vinylphenyl group, and an isoalkenyl group or an isopropenylphenyl group. Examples of the silicon compound of the above general formula (3) having this organic group include 1-hexenyltrimethoxysilane, 1-hexenyltriethoxysilane, 1-octenyltrimethoxysilane, 1-decenyltrimethoxysilane, γ-trimethoxysilylpropyl vinyl ether, ω-trimethoxysilylundecanoic acid vinyl ester, p-trimethoxysilylstyrene, 1-hexenymethyldimethoxysilane, and 1-hexenymethyldiethoxysilane. These may be used either alone respectively or in combinations with each other.

Examples of the silicon compound having the organic group containing the epoxy group include 3-glycidoxypropyltrimethoxysilane, 3-glycidoxypropylmethyldiethoxysilane, 3-glycidoxypropyltriethoxysilane, and β-(3,4-epoxycyclohexyl)ethyltrimethoxysilane. These may be used either alone respectively or in combinations with each other.

Examples of the silicon compound having the organic group containing the hydroxyl group include 3-hydroxypropyltrimethoxysilane. These may be used either alone respectively or in combinations with each other.

Examples of the silicon compound having the organic group containing the amino group include N-β(aminoethyl)γ-aminopropylmethyldimethoxysilane, N-β(aminoethyl)γ-aminopropyltrimethoxysilane, N-β(aminoethyl)γ-aminopropyltriethoxysilane, γ-aminopropyltrimethoxysilane, γ-aminopropyltriethoxysilane, and N-phenyl-γ-aminopropyltrimethoxysilane,. These may be used either alone respectively or in combinations with each other.

In addition, as to the composite particles, for example, it is favorable that:

1) in the case where the above silicon compound has, along with the hydrolyzable group, the organic group containing the polymerizable reactive group (e.g. the radically polymerizable group, the epoxy group) which can form the organic polymer framework, then: 1-1) the organic polymer framework is obtained by a process including the step of carrying out polymerization after the hydrolysis-condensation reaction of the silicon compound; or 1-2) the organic polymer framework is obtained by a process including the step of carrying out polymerization after particles having the polysiloxane framework which are obtained by the hydrolysis-condensation reaction of the silicon compound have been made to absorb a polymerizable-reactive-group-containing polymerizable monomer such as a radically polymerizable monomer, an epoxy-group-containing monomer, a hydroxyl-group-containing monomer, and an amino-group-containing monomer; and

2) in the case where the above silicon compound has no organic group containing the polymerizable reactive group (e.g. the radically polymerizable group, the epoxy group, the hydroxyl group, the amino group) which can form the organic polymer framework, then the organic polymer framework is obtained by a process including the step of carrying out polymerization after particles having the polysiloxane framework which are obtained by the hydrolysis-condensation reaction of the silicon compound have been made to absorb a polymerizable-reactive-group-containing polymerizable monomer such as a radically polymerizable monomer, an epoxy-group-containing monomer, a hydroxyl-group-containing monomer, and an amino-group-containing monomer.

As is aforementioned, the composite particles may be either in a) a form (chemical bond type) such that the polysiloxane framework has in its molecule an organosilicon atom such that a silicon atom is directly and chemically bonded to at least one carbon atom of the organic polymer framework or b) a form (IPN type) which does not have such an organosilicon atom in its molecule. Thus, there is no especial limitation. For example, in the case where the organic polymer framework is obtained along with the polysiloxane framework in the way 1-1) above, the composite particles having the form a) can be obtained and, in the case where the way 2) above is carried out, the composite particles having the form b) can be obtained. In addition, in the case where the organic polymer framework is obtained along with the polysiloxane framework in the way 1-2) above, the composite particles having a form combining the above forms a) and b) can be obtained.

As to the above ways 1-2) and 2), the radically polymerizable monomer which can be made to be absorbed into the particles having the polysiloxane framework is favorably a monomer component including a radically polymerizable vinyl monomer as an essential component.

The above radically polymerizable vinyl monomer will do if it is, for example, a compound containing an ethylenically unsaturated group in a number of at least one per molecule. Such as kind thereof is not especially limited. The radically polymerizable vinyl monomer can be selected appropriately so that the composite particles can display desired properties. The radically polymerizable vinyl monomers may be used either alone respectively or in combinations with each other. Above all, the use of a hydrophobic radically polymerizable vinyl monomer is preferable for stabilizing an emulsion when this emulsion is beforehand formed by emulsify-dispersing the above monomer component in preparation for the absorption of the above monomer component into the particles having the polysiloxane framework. Similarly, a crosslinkable monomer may be used, and the use of such a monomer enables easy adjustment of effects relating to physical properties of the resulting composite particles and is therefore favorable. In addition, it is also possible to use a radically polymerizable monomer having a hydrolyzable silyl group. Specific examples thereof include 3-(meth)acryloxypropyltrimethoxysilane, 3-(meth)acryloxypropyltriethoxysilane, 3-(meth)acryloxypropylmethyldimethoxysilane, 3-(meth)acryloxypropylmethyldiethoxysilane, vinyltrimethoxysilane, vinyltriethoxysilane, and p-trimethoxysilylstyrene. These may be used either alone respectively or in combinations with each other.

Hereinafter, descriptions are given about the process for production of the composite particles which are used as the present invention additive. Favorable examples of this process include the below-mentioned production process including a hydrolysis-condensation step and a polymerization step. If necessary, there may further be involved an absorption step in which the polymerizable monomer is made to be absorbed in a period of from after the hydrolysis-condensation step till before the polymerization step. In the case where the silicon compound to be used in the hydrolysis-condensation step is not that which has a component constituting the organic polymer framework along with a component capable of constituting the polysiloxane framework structure, then the above absorption step is indispensable, and the formation of the organic polymer framework is carried out in this absorption step.

The hydrolysis-condensation step is a step of carrying out a reaction of hydrolyzing and then condensing the aforementioned silicon compound in a water-containing solvent. By this step, the particles having the polysiloxane framework (polysiloxane particles) can be obtained. Any way of such as an all-at-once way, a divisional way, and a continuous way can be adopted for the hydrolysis and condensation. When the hydrolysis-condensation step is carried out, basic catalysts such as ammonia, urea, ethanolamine, tetramethylammonium hydroxide, alkaline metal hydroxides, and alkaline earth metal hydroxides are favorably usable as catalysts.

In the water-containing solvent, there may be contained an organic solvent besides the water and the catalyst. Examples of the organic solvent include: alcohols such as methanol, ethanol, isopropanol, n-butanol, isobutanol, sec-butanol, t-butanol, pentanol, ethylene glycol, propylene glycol, and 1,4-butanediol; ketones such as acetone and methyl ethyl ketone; esters such as ethyl acetate; (cyclo)paraffins such as isooctane and cyclohexane; and aromatic hydrocarbons such as benzene and toluene. These may be used either alone respectively or in combinations with each other.

In addition, in the hydrolysis-condensation step, it is also possible to further use anionic, cationic, and nonionic surfactants or high-molecular dispersants (e.g. poly(vinyl alcohol), poly(vinylpyrrolidone)). These may be used either alone respectively or in combinations with each other.

The hydrolysis and condensation can, for example, be carried out by a process including the steps of adding the above silicon compound (which is used as a starting material), the catalyst, and the organic solvent to the water-containing solvent and then stirring them together in the range of 0 to 100° C., favorably 0 to 70° C., for 30 minutes to 100 hours. In addition, it is also possible that: particles, which have once been obtained by carrying out the reaction to a desired degree by the above process, are beforehand charged as seed particles into a reaction system, and then the silicon compound is further added to make the seed particles grow.

As is aforementioned, depending on the silicon compound being used, there are some cases where the absorption step should be an indispensable step, and there are other cases where the absorption step may be an optional step.

In the absorption step, the polymerizable monomer is added to the polysiloxane particles. The absorption step will do if the absorption is carried out finally in a state where the above polymerizable monomer is made to exist in the presence of the polysiloxane particles. Therefore, although not especially limited, for example, the polymerizable monomer may be added into a solvent into which the polysiloxane particles have been dispersed, or the polysiloxane particles may be added into a solvent containing the polymerizable monomer. Above all, there is preferred the former mode in which the polymerizable monomer is added into a solvent into which the polysiloxane particles have beforehand been dispersed. A more favorable mode is that the polymerizable monomer is added to a polysiloxane particles dispersion without getting the polysiloxane particles out of this dispersion, wherein this dispersion is obtained by synthesizing the polysiloxane particles. Because this mode needs no complicated step and is excellent in the productivity.

In the absorption step, the above polymerizable monomer is made to be absorbed into the structure of the polysiloxane particles. When the above polymerizable monomer is added to the polysiloxane particles, it is favorable that various conditions are set so that the above absorption can be facilitated, and that, under these set conditions, the above addition is carried out. Examples of such conditions include: respective concentrations of the polysiloxane particles and the polymerizable monomer; the mixing ratio between the polysiloxane particles and the polymerizable monomer; treatment methods and means for the mixing; the temperature and time during the mixing; and treatment methods and means after the mixing. As to these conditions, their necessity may be taken into consideration appropriately for such as the kinds of the polysiloxane particles and polymerizable monomer being used. In addition, these conditions may be applied either alone respectively or in combinations with each other.

When the above polymerizable monomer is added in the absorption step, it is favorable that the above polymerizable monomer is added in an amount by weight of 0.01 to 100 times relative to the weight of the silicon compound used as a starting material for the polysiloxane particles. In the case where the above addition amount is smaller than 0.01 time, there is a possibility that the amount of the absorption of the above polymerizable monomer into the polysiloxane particles may be so small as to result in low adhesion of the obtained composite particles into the resin. In the case where the above addition amount is larger than 100 times, there is a possibility that it may be so difficult to make the added polymerizable monomer entirely absorbed into the polysiloxane particles that an unabsorbed polymerizable monomer remains, thus there being a tendency for cohesion between particles to occur in the polymerization step being carried out after.

When the polymerizable monomer is added in the absorption step, the polymerizable monomer may be added all at once, or may be added several divided times, or may be fed at any rate, thus there being no especial limitation. In addition, when the polymerizable monomer is added, the polymerizable monomer may be added alone, or may be added in the form of a solution of the polymerizable monomer. However, there is preferred a mode in which the polymerizable monomer is added to the polysiloxane particles in a state where the polymerizable monomer has beforehand been emulsify-dispersed, because such a mode makes it possible to more efficiently carry out the absorption into the above particles.

As to the above emulsify-dispersing, usually, it is favorable that the above monomer component is brought into a state emulsified in water by using such as a homomixer or an ultrasonic homogenizer along with an emulsifier.

As to a judgment of whether the monomer component has been absorbed into the polysiloxane particles in the absorption step or not, this judgment can easily be made, for example, by observing the particles with a microscope before the addition of the monomer component and after the end of the absorption step and thereby confirming whether the particle diameters have been increased by the absorption of the monomer component.

The polymerization step is a step of making a polymerization reaction of the polymerizable reactive group to thus obtain the particles having the organic polymer framework. Specifically, in the case where the silicon compound having the polymerizable-reactive-group-containing organic group is used as the silicon compound, the polymerization step is a step of polymerizing the polymerizable reactive group of the organic group to thus form the organic polymer framework. In the case where the absorption step has been carried out, the polymerization step is a step of polymerizing the absorbed polymerizable-reactive-group-containing polymerizable monomer to thus form the organic polymer framework. In the case corresponding to both, the polymerization step can be a step of forming the organic polymer framework by either reaction.

The polymerization reaction may be carried out on the way of the hydrolysis-condensation step or absorption step, or may be carried out after either or both of these steps, thus there being no especial limitation. However, it is usual to start the polymerization reaction after the hydrolysis-condensation step (or after the absorption step in the case where the absorption step has been carried out).

After the polymerization step, it is also possible that a prepared liquid containing the resultant particles is used as it is. However, the prepared liquid may be used after the organic solvent has been displaced with a dispersion medium (including water and/or an alcohol) by distillation. In addition, it is also possible to isolate the particles by hitherto publicly known methods such as filtration, centrifugal separation, and vacuum concentration. In addition, the particles can be made particles having a desired particle diameter distribution by classification. After the isolation, if necessary, the resultant composite particles can be processed by a heat treatment step for the purpose of drying and calcination.

The heat treatment step is a step in which the composite particles formed in the polymerization step are dried and calcined at a temperature of not higher than 500° C., preferably 50 to 300° C. For example, the heat treatment step is favorably carried out under an atmosphere having an oxygen concentration of not more than 10 volume % or under a reduced pressure. By carrying out the heat treatment step, the softness and elasticity of the composite particles obtained from the polymerization step can be enhanced more.

[Optical Resin Composition]:

The optical resin composition according to the present invention (which may hereinafter be referred to as present invention resin composition) comprises the aforementioned additive for optical resins, according to the present invention, and a transparent resin as an optical resin.

Although not especially limited, the form of the present invention resin composition may be, for example, as follows: 1) a resin composition obtained by a process including the steps of adding and dispersing the present invention additive into a base resin as the transparent resin; or 2) a resin composition obtained by a process including the step in which a mixture including a binder resin (as the transparent resin) and the present invention additive is laminated (coated) onto a surface of a predetermined base material.

In the case of the above form 1), favorable examples of the base resin include polyester resins (e.g. poly(ethylene terephthalate), poly(ethylene naphthalate)), acrylic resins, polystyrene resins, polycarbonate resins, polyether sulfone resins, polyurethanic resins, polysulfone resins, polyether resins, polymethylpentene resins, polyether ketone resins, (meth)acrylonitrile resins, polyolefin resins, norbornenic resins, amorphous polyolefin resins, polyamide resins, polyimide resins, and triacetyl cellulose resins. However, there is no especial limitation to these.

The optical resin composition of the above form 1) is, for example, employed for optical uses such as light-diffusing plates (light-diffusing sheets), light-leading plates, plastic substrates for various displays, and substrates for touch panels.

In the case of the above form 2), favorable examples of the binder resin include acrylic resins, polypropylene resins, poly(vinyl alcohol) resins, poly(vinyl acetate) resins, polystyrene resins, poly(vinyl chloride) resins, silicone resins, and polyurethane resins. However, there is no especial limitation to these.

The optical resin composition of the above form 2) is, for example, employed for optical uses such as light-diffusing plates (light-diffusing sheets), light-leading plates, plastic substrates for various displays, and substrates for touch panels.

In the present invention resin composition, the content of the present invention additive should appropriately be selected in consideration of optical properties to be obtained and is therefore not especially limited. However, this content is favorably in the range of 0.001 to 95 weight %, more favorably 0.01 to 93 weight %, still more favorably 0.05 to 90 weight %, relative to the entire resin composition. In the case where the content of the present invention additive is lower than 0.001 weight %, for example, there is a possibility that the light diffusion efficiency may be deteriorated in uses to which the light diffusibility is demanded. In the case where the content of the present invention additive is higher than 95 weight %, there is a possibility that the strength of the optical resin composition itself may be deteriorated.

The method for adding the present invention additive to the transparent resin in order to obtain the present invention resin composition is free of especial limitation if it is a method in which the composite particles used as the present invention additive are dispersed uniformly into the transparent resin. However, this method may be a method in which a liquid dispersion of the composite particles is added to the transparent resin or may be a method in which the composite particles are, as they are, added into the resin.

Examples of processes for obtaining the optical resin composition of the above form 1) include a process including the steps of: mixing the present invention additive into the base resin; and then extruding the resultant mixture while melt-kneading it with an appropriate extruder, thus forming pellets. Besides, if necessary, it is also possible to form the above optical resin composition by processes further including the step of adding various additives for enhancing the properties such as weather resistance and UV resistance and other additives such as stabilizing agents and flame retardants.

Examples of methods for laminating the mixture including the binder resin and the present invention additive in order to obtain the optical resin composition of the above form 2) include publicly known various lamination methods such as reverse roll coat methods, gravure coat methods, die coat methods, comma coat methods, and spray coat methods.

### DETAILED DESCRIPTION OF THE PREFERRED EMBODIMENTS

Hereinafter, the present invention is more specifically illustrated by the following Examples of some preferred embodiments in comparison with Comparative Examples not according to the present invention. However, the present invention is not limited to these in any way. Incidentally, hereinafter, for convenience, the unit “weight part(s)” may be referred to simply as “part(s)”.

The evaluation and measurement methods in the Examples and the Comparative Examples are shown below.

[Tendency for Additive Particles to Fall Off]:

The tendency for the resultant additive particles (additive for optical resins) to fall off from the optical resin composition was measured and evaluated by the following method.

An amount of 10 parts of additive particles to be evaluated were added to 100 parts of a binder resin (PET, PEN, PC or PMMA), and then they were mixed with Henschel Mixer, and then the resultant mixture was melt-kneaded with a 65 mm single-screw extruder, thus producing pellets. The resultant pellets were molded with an injection molding machine, thus preparing a test piece for evaluation of the falling-off tendency.

A surface of the produced test piece was rubbed with rayon-made cloth 20 times, and then a surface of the cloth was observed with a microscope to evaluate it on the following standards: a case where the additive particles were seen in a large amount was marked “X”; a case where the additive particles were seen in a small amount was marked “Δ”; a case where the additive particles were seen though in a slight amount was marked “◯”; and a case where the additive particles were not seen at all was marked “⊚”.

[Luminance Unevenness of Light-Diffusing Sheet]:

The resultant light-diffusing sheet (one-side length: 150 mm, thickness: 30 μm) was layered over a light-leading plate of a backlight module for liquid crystal displays, wherein an end side of the light-leading plate was equipped with one cold-cathode tube (diameter: 3 mm, length: 170 mm). A luminometer (CS-100, produced by Minolta Inc.) was set at a distance of 30 cm from the surface of the light-diffusing sheet to measure any ten spots by the luminance. The in-plane luminance unevenness of the light-diffusing sheet was evaluated on the below-mentioned standards.

Incidentally, the samples used as the light-diffusing sheets to be measured and evaluated were as follows: (1) a sample obtained by rubbing a surface of the light-diffusing sheet with rayon-made cloth 20 times (a sample after a friction test); and (2) a sample obtained by bending the light-diffusing sheet at different creases 20 times (a sample after a bending test).

⊚: There is no luminance unevenness.

◯: There is slightly partly luminance unevenness.

Δ: There is partly luminance unevenness.

X: There is luminance unevenness all over the surface.

[Face Luminescence of Light-Diffusing Sheet]:

The resultant light-diffusing sheet (one-side length: 150 mm, thickness: 30 μm) was layered over a light-leading plate of a backlight module for liquid crystal displays, wherein an end side of the light-leading plate was equipped with one cold-cathode tube (diameter: 3 mm, length: 170 mm). A luminometer (CS-100, produced by Minolta Inc.) was set at a distance of 30 cm from the surface of the light-diffusing sheet to measure the entire surface of the light-diffusing sheet by the luminance. The in-plane face luminescence of the sheet was evaluated on the below-mentioned standards.

Incidentally, the samples used as the light-diffusing sheets to be measured and evaluated were the same samples (1) and (2) as were measured and evaluated above by the luminance unevenness.

⊚: The luminous face is very clear.

◯: The luminous face is clear.

Δ: The luminous face is somewhat dark.

X: The luminous face is dark.

[Luminance Unevenness of Light-Leading Plate]:

The resultant light-leading plate (one-side length: 150 mm, thickness: 4 mm) was layered over an upper portion of a white reflecting plate of 150 mm in one-side length and 2 mm in thickness, and then an end side of the light-leading plate was equipped with a cold-cathode tube (diameter: 3 mm, length: 170 mm).

A luminometer (CS-100, produced by Minolta Inc.) was set at a distance of 30 cm from the surface of the light-leading plate to measure any ten spots by the luminance. The in-plane luminance unevenness of the light-leading plate was evaluated on the below-mentioned standards.

Incidentally, the samples used as the light-leading plates to be measured and evaluated were as follows: (1) a sample obtained by rubbing a surface of the light-leading plate with rayon-made cloth 20 times (a sample after a friction test); and (2) a sample obtained by bending the light-leading plate at different creases 20 times (a sample after a bending test).

⊚: There is no luminance unevenness.

◯: There is slightly partly luminance unevenness.

Δ: There is partly luminance unevenness.

X: There is luminance unevenness all over the surface.

[Face Luminescence of Light-Leading Plate]:

The resultant light-leading plate (one-side length: 150 mm, thickness: 4 mm) was layered over an upper portion of a white reflecting plate of 150 mm in one-side length and 2 mm in thickness, and then an end side of the light-leading plate was equipped with a cold-cathode tube (diameter: 3 mm, length: 170 mm).

A luminometer (CS-100, produced by Minolta Inc.) was set at a distance of 30 cm from the surface of the light-leading plate to measure the entire surface of the light-leading plate by the luminance. The in-plane face luminescence of the light-leading plate was evaluated on the below-mentioned standards.

Incidentally, the samples used as the light-leading plates to be measured and evaluated were the same samples (1) and (2) as were measured and evaluated above by the luminance unevenness.

⊚: The luminous face is very clear.

◯: The luminous face is clear.

Δ: The luminous face is somewhat dark.

X: The luminous face is dark.

### EXAMPLE 1

(Preparation of Additive for Optical Resins (Additive Particles)):

A mixed solution of 650 parts of ion-exchanged water, 2.6 parts of 25% ammonia water, and 322 parts of methanol was placed into a flask as equipped with a condenser, a thermometer, and a dropping inlet. While this mixed solution was stirred, 24 parts of γ-methacryloxypropyltrimethoxysilane was added from the dropping inlet to the mixed solution to initiate a reaction, and then the stirring was continued for 2 hours. Separately, a material, having been prepared by adding 4.8 parts of an anionic surfactant (N-08, produced by Dai-ichi Kogyo Seiyaku Co., Ltd.) and 240 parts of ion-exchanged water to a mixed solution of 480 parts of styrene and 10.1 parts of 2,2′-azobis(2,4-dimethylvaleronitrile) (V-65, produced by Wako Pure Chemical Industries, Ltd.), was emulsify-dispersed with a homomixer for 15 minutes to prepare an emulsion. This emulsion was added from the dropping inlet after 2 hours from the aforementioned reaction initiation (after the 2-hour stirring). After this addition, the stirring was continued for another 1 hour. The resultant reaction liquid was heated to 65° C. under a nitrogen atmosphere and then retained at 65±2° C. for 2 hours to carry out a radical polymerization reaction. After this polymerization reaction, the resultant emulsion was solid-liquid-separated by spontaneous sedimentation. The resultant cake was washed with ion-exchanged water and methanol and then vacuum-dried at 100° C. for 5 hours, thereby obtaining a dried material resultant from cohesion of particles. This dried material was disintegrated with a laboratory jet to thereby obtain particles (additive particles (1)).

The particle diameters of the additive particles (1) were measured with Coulter Multisizer (produced by Beckmann Coulter Electronic, Inc.). As a result, the average particle diameter was 10.0 μm, and the coefficient of variation in particle diameter was 3.2%.

The falling-off tendency of the additive particles (1) was evaluated by the aforementioned method. Its result is shown in Table 1.

(Production of Light-Diffusing Sheet):

A varnish, having been prepared by mixing 20 parts of an acrylic resin, 40 parts of the additive particles (1), and 60 parts of a solvent (toluene) together to form a dispersion, was coated onto a surface of a polyester (PET) film of 100 μm in thickness by a die coat method, thus producing a light-diffusing layer of 30 μm in thickness. Thereafter, this light-diffusing layer was isolated from the PET film, thus obtaining a light-diffusing sheet (1).

The luminance unevenness and face luminescence of the resultant light-diffusing sheet (1) were evaluated by the aforementioned methods. Their results are shown in Tables 2 and 3.

(Production of Light-Leading Plate):

An amount of 0.1 part of the additive particles (1) were added to 100 parts of an aromatic polycarbonate resin, and then they were melt-kneaded with a single-screw extruder, thus obtaining pellets. The resultant pellets were dried at 120° C. with a hot-air-circulating type drier for 5 hours and then molded into the shape of a plate of 150 mm in one-side length and 4 mm in thickness with an injection molding machine, thus obtaining a light-leading plate (1).

The luminance unevenness and face luminescence of the resultant light-leading plate (1) were evaluated by the aforementioned methods. Their results are shown in Tables 2 and 3.

### EXAMPLE 2

A mixed solution of 650 parts of ion-exchanged water and 2.6 parts of 25% ammonia water was placed into a flask as equipped with a condenser, a thermometer, and a dropping inlet. While this mixed solution was stirred, 50 parts of γ-methacryloxypropyltrimethoxysilane and a solution (this solution had been prepared by dissolving 10.1 parts of 2,2′-azobis(2,4-dimethylvaleronitrile) (V-65, produced by Wako Pure Chemical Industries, Ltd.) into 322 parts of methanol) were added from the dropping inlet to the mixed solution to initiate a reaction, and then the stirring was continued for 2 hours. The resultant reaction liquid was heated to 65° C. under a nitrogen atmosphere and then retained at 65±2° C. for 2 hours to carry out a radical polymerization reaction. After this polymerization reaction, the resultant emulsion was solid-liquid-separated by spontaneous sedimentation. The resultant cake was washed with ion-exchanged water and methanol and then vacuum-dried at 100° C. for 5 hours, thereby obtaining a dried material resultant from cohesion of particles. This dried material was disintegrated with a laboratory jet to thereby obtain particles (additive particles (2)).

The particle diameters of the additive particles (2) were measured with Coulter Multisizer (produced by Beckmann Coulter Electronic, Inc.). As a result, the average particle diameter was 12.0 μm, and the coefficient of variation in particle diameter was 2.5%.

The falling-off tendency of the additive particles (2) was evaluated by the aforementioned method. Its result is shown in Table 1.

Next, a light-diffusing sheet (2) and a light-leading plate (2) were produced in the same way as of Example 1 except that the additive particles (1) were replaced with the additive particles (2).

The luminance unevenness and face luminescence of each of the resultant light-diffusing sheet (2) and the resultant light-leading plate (2) were evaluated by the aforementioned methods. Their results are shown in Tables 2 and 3.

### COMPARATIVE EXAMPLE 1

A mixture of divinylbenzene, styrene, and dipentaerythritol hexaacrylate was suspension-polymerized, and then the resultant cake was washed with ion-exchanged water and methanol and then vacuum-dried at 100° C. for 5 hours, thereby obtaining a dried material resultant from cohesion of particles. This dried material was disintegrated with a laboratory jet to thereby obtain particles (additive particles (c1)).

The particle diameters of the additive particles (c1) were measured with Coulter Multisizer (produced by Beckmann Coulter Electronic, Inc.). As a result, the average particle diameter was 12.0 μm, and the coefficient of variation in particle diameter was 45%.

The falling-off tendency of the additive particles (c1) was evaluated by the aforementioned method. Its result is shown in Table 1.

Next, a light-diffusing sheet (c1) and a light-leading plate (c1) were produced in the same way as of Example 1 except that the additive particles (1) were replaced with the additive particles (c1).

The luminance unevenness and face luminescence of each of the resultant light-diffusing sheet (c1) and the resultant light-leading plate (c1) were evaluated by the aforementioned methods. Their results are shown in Tables 2 and 3.

### COMPARATIVE EXAMPLE 2

A mixture of methyl methacrylate, ethylene glycol dimethacrylate, and 2-methacryloyloxyethyl hexahydrophthalate was suspension-polymerized, and then the resultant cake was washed with ion-exchanged water and methanol and then vacuum-dried at 100° C. for 5 hours, thereby obtaining a dried material resultant from cohesion of particles. This dried material was disintegrated with a laboratory jet to thereby obtain particles (additive particles (c2)).

The particle diameters of the additive particles (c2) were measured with Coulter Multisizer (produced by Beckmann Coulter Electronic, Inc.). As a result, the average particle diameter was 12.0 μm, and the coefficient of variation in particle diameter was 45%.

The falling-off tendency of the additive particles (c2) was evaluated by the aforementioned method. Its result is shown in Table 1.

Next, a light-diffusing sheet (c2) and a light-leading plate (c2) were produced in the same way as of Example 1 except that the additive particles (1) were replaced with the additive particles (c2).

The luminance unevenness and face luminescence of each of the resultant light-diffusing sheet (c2) and the resultant light-leading plate (c2) were evaluated by the aforementioned methods. Their results are shown in Tables 2 and 3.

### COMPARATIVE EXAMPLE 3

A mixed solution of 650 parts of ion-exchanged water and 1.0 part of 25% ammonia water was placed into a flask as equipped with a condenser, a thermometer, and a dropping inlet. While this mixed solution was stirred, 100 parts of γ-methacryloxypropyltrimethoxysilane and a solution (this solution had been prepared by dissolving 10.1 parts of 2,2′-azobis(2,4-dimethylvaleronitrile) (V-65, produced by Wako Pure Chemical Industries, Ltd.) into 322 parts of methanol) were added from the dropping inlet to the mixed solution to initiate a reaction, and then the stirring was continued for 2 hours. The resultant reaction liquid was heated to 65° C. under a nitrogen atmosphere and then retained at 65±2° C. for 2 hours to carry out a radical polymerization reaction. After this polymerization reaction, the resultant emulsion was solid-liquid-separated by spontaneous sedimentation. The resultant cake was washed with ion-exchanged water and methanol and then calcined at 900° C. for 5 hours to thereby obtain silica particles (additive particles (c3)).

The particle diameters of the additive particles (c3) were measured with Coulter Multisizer (produced by Beckmann Coulter Electronic, Inc.). As a result, the average particle diameter was 10.5 μm, and the coefficient of variation in particle diameter was 5.5%.

The falling-off tendency of the additive particles (c3) was evaluated by the aforementioned method. Its result is shown in Table 1.

Next, a light-diffusing sheet (c3) and a light-leading plate (c3) were produced in the same way as of Example 1 except that the additive particles (1) were replaced with the additive particles (c3).

The luminance unevenness and face luminescence of each of the resultant light-diffusing sheet (c3) and the resultant light-leading plate (c3) were evaluated by the aforementioned methods. Their results are shown in Tables 2 and 3.

### COMPARATIVE EXAMPLE 4

Commercially available spherical fine silicone particles (Tospearl 120, produced by Toshiba Silicone Co., Ltd.) (additive particles (c4)) were prepared.

The particle diameters of the additive particles (c4) were measured with Coulter Multisizer (produced by Beckmann Coulter Electronic, Inc.). As a result, the average particle diameter was 2.0 μm, and the coefficient of variation in particle diameter was 8.2%.

The falling-off tendency of the additive particles (c4) was evaluated by the aforementioned method. Its result is shown in Table 1.

Next, a light-diffusing sheet (c4) and a light-leading plate (c4) were produced in the same way as of Example 1 except that the additive particles (1) were replaced with the additive particles (c4).

The luminance unevenness and face luminescence of each of the resultant light-diffusing sheet (c4) and the resultant light-leading plate (c4) were evaluated by the aforementioned methods. Their results are shown in Tables 2 and 3.

TABLE 1
<Results of evaluation of tendency to fall off from resin composition >

| | Binder resin | | | |
|---|---|---|---|---|
| | PET | PEN | PC | PMMA |
| Example 1 | ⊚ | ⊚ | ⊚ | ⊚ |
| Example 2 | ⊚ | ⊚ | ⊚ | ⊚ |
| Gomparative | Δ | Δ | Δ | Δ |
| Example 1 | | | | |
| Comparative | ◯ | ◯ | ◯ | ◯ |
| Example 2 | | | | |
| Comparative | X | X | X | X |
| Example 3 | | | | |
| Comparative | Δ | Δ | Δ | Δ |
| Example 4 | | | | |

(Notes)
PET: Poly(ethylene terephthalate)
PEN: Poly(ethylene naphthalate)
PC: Polycarbonate
PMMA: Poly(methyl methacrylate)

TABLE 2
<Results of evaluation of light-diffusing sheet by
luminance unevenness and face luminescence>

| | Luminance unevenness | | Face luminescence | |
|---|---|---|---|---|
| | (1) | (2) | (1) | (2) |
| Example 1 | ⊚ | ⊚ | ⊚ | ⊚ |
| Example 2 | ⊚ | ⊚ | ⊚ | ⊚ |
| Comparative | Δ | X | ◯ | Δ |
| Example 1 | | | | |
| Comparative | ◯ | Δ | ◯ | Δ |
| Example 2 | | | | |
| Comparative | X | X | X | X |
| Example 3 | | | | |
| Comparative | Δ | Δ | Δ | Δ |
| Example 4 | | | | |

(Notes)
(1): After friction test
(2): After bending test

TABLE 3
<Results of evaluation of light-leading plate by
luminance unevenness and face luminescence>

| | Luminance unevenness | | Face luminescence | |
|---|---|---|---|---|
| | (1) | (2) | (1) | (2) |
| Example 1 | ⊚ | ⊚ | ⊚ | ⊚ |
| Example 2 | ⊚ | ⊚ | ⊚ | ⊚ |
| Comparative | Δ | X | ◯ | Δ |
| Example 1 | | | | |
| Comparative | ◯ | Δ | ◯ | Δ |
| Example 2 | | | | |
| Comparative | X | X | X | X |
| Example 3 | | | | |
| Comparative | Δ | Δ | Δ | Δ |
| Example 4 | | | | |

(Notes)
(1): After friction test
(2): After bending test

### INDUSTRIAL APPLICATION

The present invention can provide an additive for optical resins, wherein, even taking optical uses into consideration, the additive falls off little from such as binder resin layers or resin base materials and enables the exercise of uniform light diffusibility, without luminance unevenness, and high face luminescence. The present invention can further provide an optical resin composition which comprises the above additive and a transparent resin and can display very excellent performances in optical properties such as no luminance unevenness and the face luminescence in the case of being employed for optical uses. In addition, if the present invention additive for optical resins is used, then the productivity enhancement and the enhancement of economical advantages in point of such as cost can also be achieved, and it is also possible to provide an optical resin composition which involves little light loss as an optical material and is excellent also in the physical performances such as physical strength and softness.

1. An additive for optical resins, comprising organic-inorganic-composite particles having a structure including an organic polymer framework and a polysiloxane framework as essential frameworks.

2. An optical resin composition, comprising the additive for optical resins as recited in claim 1 and a transparent resin.
